SEQUENCE LISTING (1 sequence)

SEQ ID NO: 1 - protein, 53 aa, Homo sapiens
NSDSECPLSHDGYCLHDGVCMYIEALDKYACNCVVGYIGERCQYRDLKWWELR

(19) United States
(12) Patent Application Publication
(10) Pub. No.: US 2005/0275799 A1
(43) Pub. Date: Dec. 15, 2005

(54) Contact lenses, package systems, and method for promoting a healthy epithelium of an eye

(76) Inventor: J. Christopher Marmo, Danville, CA (US)

Correspondence Address: STOUT, UXA, BUYAN & MULLINS LLP, 4 VENTURE, SUITE 300, IRVINE, CA, 92618, US

(21) Appl. No.: 11/074,815

(22) Filed: Mar. 8, 2005

Related U.S. Application Data
(60) Provisional application No. 60/551,834, filed on Mar. 10, 2004.

(51) Int. Cl. G02C 7/10

(52) U.S. Cl. 351/160 H

(57) ABSTRACT

A contact lens is described that comprises a lens body and an epithelial growth factor (EGF) component. The EGF component is effective in maintaining a healthy epithelium of an eye on which the lens is placed. The EGF component includes an EGF, and preferably a human EGF. The lens may be effective in reducing irritation associated with conventional contact lenses, and also may be effective in treating dry eye and/or reducing infection of an eye. Packaging systems and method of manufacturing such lenses are also described.

### CROSS-REFERENCE TO RELATED APPLICATIONS

This application claims the benefit of U.S. Provisional Application No. 60/551,834, filed Mar. 10, 2004, the entire content of which is hereby incorporated by reference.

### BACKGROUND OF THE INVENTION

The present invention relates to contact lenses, packaging systems containing contact lenses, and methods of making contact lenses. More particularly the invention relates to contact lenses, for example, disposable contact lenses, including an epithelial growth factor component that is effective to promote a healthy epithelium of an eye on which the contact lens is located, and packaging systems for use with same and methods of producing same.

U.S. Pat. No. 5,112,350 discloses a method for locating an artificial lens fabricated from a collagen-hydrogel for promoting epithelial cell growth and regeneration of the stroma on a cornea. The method includes affixing an artificial lens to the Bowman's membrane. The lens promotes and supports epithelial cell growth over the anterior surface of the lens so epithelial cells attach to and cover the anterior surface of the lens.

U.S. Pat. No. 5,716,633 discloses a collagen-hydrogel for promoting epithelial cell growth and regeneration of the stroma. A lens fabricated from the collagen-hydrogel, when affixed to Bowman's membrane, promotes and supports epithelial cell growth over the anterior surface of the lens.

U.S. Pat. No. 6,689,165 discloses a synthetic device for cornea augmentation and replacement that increases corneal epithelium cell adhesion and migration over the anterior surface of the device, such as a corneal onlay or lenticule. Tethered extracellular matrix proteins (ECMPs), corneal growth factors, and other ligand-specific corneal enhancer species on the polymeric surface of an artificial cornea help facilitate epithelial cell growth over the device.

The foregoing devices are not easily removable since they are placed under the epithelium of an eye. For example, such devices cannot be removed by the person in which the devices have been implanted.

Currently, contact lenses, i.e., lenses that are placed on an eye to cover the epithelium of the eye, may irritate the underlying epithelium and may result in an unhealthy epithelium if worn for long periods of time. The irritation may result in conditions similar to “dry eye”, a condition characterized by reduced moisture and lubrication of the eye. Sensations associated with dry eye include dryness, scratchiness, and burning of the eye. The irritation may also provide for an increased risk of an infection of the eye. One important reason for contact lens wearers quitting wearing contact lenses is end of the day discomfort and dryness.

Thus, there remains a need for contact lenses that promote a healthy epithelium, which may be effective in reducing infection and irritation of the eye as well as conditions similar to dry eye. Packaging systems and methods of producing such contact lenses are also needed.

### SUMMARY OF THE INVENTION

A contact lens is disclosed that is effective in promoting a healthy epithelium. The contact lens is structured to be temporarily placed on an eye of a person for a period of time, such as a day, a week, or a month. The contact lens may be worn to improve a person's vision, or may be worn for cosmetic reasons. The contact lens may be a daily disposable contact lens, or continuous wear contact lens (e.g., worn for more than one day). The contact lens may be effective in reducing one or more sensations associated with conditions like dry eye, for example, dryness, burning, and scratching. In addition, the contact lens may be effective in reducing infections of the eye associated with wearing contact lenses. The present contact lenses attempt to improve the comfort of the person wearing the lenses at the end of the day, among other things.

In one embodiment, a contact lens comprises a lens body and an epithelial growth factor (EGF) component provided on or in the lens body. The lens body has an anterior surface and a posterior surface. The posterior surface is structured or otherwise configured to be placed on or over an epithelium of an eye, such as an intact epithelium. The EGF component comprises an amount of EGF effective to promote a healthy epithelium of an eye on which the contact lens is placed. The EGF is preferably a human EGF. In certain embodiments, the EGF component may comprise gamma-hEGF or beta-hEGF, or a combination thereof. In one particular embodiment, the EGF component of the lens includes an EGF that has an amino acid sequence of SEQ ID NO: 1.

In one embodiment, the EGF of the EGF component may be provided in a fluid or liquid. Thus, the EGF component may be a fluid or a liquid in which the contact lens has been placed. For example, the EGF component may be a liquid of a contact lens packaging system, and may be provided on or in the contact lens when the lens is placed in the liquid. When such a lens is removed from the packaging system, the lens includes the liquid containing the EGF when the lens is placed on an eye.

In another embodiment, the EGF component includes an EGF that is coupled to a polymeric material of the contact lens. The coupling may be made by way of a labile bond. For example, the labile bond may be a covalent bond. The coupling is effective to permit the EGF to be released over a period of time when the contact lens is located on an eye. Thus, the contact lens may be understood to provide for an extended release of EGF onto an eye. For example, the EGF may be released selectively from the posterior surface of the contact lens towards the epithelium. Such contact lenses may be continuous wear contact lenses, such as contact lenses that are worn for at least a week, and sometimes for as long as one month. However, daily disposable contact lenses may also include an EGF component comprising an EGF that is coupled to the material from which the lens is formed.

In another embodiment of the present invention, a package system comprises a contact lens; a liquid medium comprising an amount of EGF effective to promote a healthy epithelium of an eye on which the contact lens is placed; and a container holding the contact lens and the liquid medium. The package system may be for daily disposable contact lenses, such as lenses configured to be worn for one day and then discarded, or for continuous wear contact lenses, such as lenses that are worn for at least about seven days, and possibly for at least about thirty days. The system may include a seal that keeps the lens and the liquid medium in a sterile environment until the lens is removed from the package system.

In yet another embodiment, a method of producing a contact lens, comprises combining a polymeric material suitable for forming a contact lens to be placed on an epithelium of an eye with an amount of EGF effective to promote a healthy epithelium on the eye on which the contact lens is to be placed. The EGF may be added to the polymeric material as the contact lens is being formed or shaped, or the EGF may be combined with the polymeric material after the lens has been shaped, such as when the lens is placed in a package system, as described herein.

Each and every feature described herein, and each and every combination of two or more of such features, is included within the scope of the present invention provided that the features included in such a combination are not mutually inconsistent. In addition, any feature or combination of features may be specifically excluded from any embodiment of the present invention.

These and other aspects of the present invention are set forth in the following detailed description and claims, particularly when considered in conjunction with the accompanying drawings in which like parts bear like reference numerals.

### BRIEF DESCRIPTION OF THE DRAWINGS

FIG. 1 is a schematic illustration of a packaging system containing a contact lens.

### DETAILED DESCRIPTION OF THE INVENTION

The present invention relates to a contact lens that is effective to promote a healthy epithelium of an eye on which the lens is placed. Thus, the contact lens disclosed herein attempts to reduce irritation associated with conventional contact lenses. In addition, the contact lens may be effective in treating or reducing sensations similar to those of dry eye, and may be effective in reducing possibility of infection of an eye.

A contact lens in accordance with the disclosure herein comprises a contact lens body and an epithelial growth factor (EGF) component provided on or in the contact lens body. A contact lens in accordance with the disclosure herein refers to a lens, vision correcting and/or cosmetic, such as tinted or colored, that is placed on or over an epithelium of an eye. In other words, the contact lens comprises a lens body that has an anterior surface and a posterior surface. The posterior surface is structured or shaped to be placed on an epithelium of an eye. Thus, the phrase “contact lens” specifically excludes lenses or other ocular devices that are placed beneath an epithelium of an eye.

The lens body of a contact lens of the present invention may comprise a hydrophilic polymeric material. For example, the lens body may comprise a hydrophilic polymeric material that is obtained by polymerization of at least one hydrophilic monomeric component.

In certain embodiments, the hydrophilic polymeric material is obtained by polymerization of at least one hydrophilic monomeric component and at least one cross-linking monomeric component. Suitable hydrophilic monomeric components may include hydroxyalkyl acrylates, hydroxyalkyl methacrylates, N-vinyl pyrrolidone, acrylamides, vinyl alcohol, hydrophilic polyurethane precursors, glycerol acrylates, glycerol methacrylates, acrylates, methacrylates, substituted counterparts thereof and the like, and mixtures thereof.

The contact lens may be a hydrogel. In certain embodiments, the contact lens may be a silicone hydrogel. For example, the lens body of the contact lens may comprise a silicone hydrogel material.

In some embodiments, the lens body comprises a polymeric material other than collagen. For example, the lens body may comprise a polymeric material that is substantially free of collagen, or a polymeric material in which a minor portion (e.g., less than fifty percent) of the material is made of collagen.

The EGF component of the contact lens comprises an amount of EGF that is effective to promote a healthy epithelium of an eye on which the contact lens is placed. The EGF is preferably a human EGF (hEGF).

Human EGF is a polypeptide which exists as a 53 amino acid form (beta-hEGF) or a 52 amino acid form (gamma-hEGF). The beta-hEGF and gamma-hEGF forms are identical except that the gamma-hEGF form lacks the C-terminal arginine residue found on beta-hEGF form. The amino acid sequences for both forms are reported in Hollenberg “Epidermal Growth Factor-Urogastrone, a Polypeptide Acquiring Hormonal Status”, Academic Press, Inc., New York (1979), pp. 69-110. Human epidermal growth factor is also known as human epithelial growth factor. The amino acid sequence of beta-hEGF is:
NSDSECPLSH DGYCLHDGVC MYIEALDKYA CNCVVGYIGE RCQYRDLKWW ELR (SEQ ID NO: 1)

In view of the above, gamma-hEGF lacks the C-terminal arginine of SEQ ID NO: 1. Human EGF may be obtained using any conventional technique, such as the techniques disclosed in U.S. Pat. Nos. 4,621,052; 4,959,353; and 5,096,825. In addition, hEGF may be obtained from companies, such as Chiron Vision.

In certain embodiments, the EGF component of the contact lens may comprise a single EGF form, such as a gamma-EGF form or a beta-EGF form, or the EGF component may comprise a combination of gamma-EGF and beta-EGF forms. In one embodiment, the EGF component comprises, consists essentially of, or consists of, an EGF that has the amino acid sequence of SEQ ID NO: 1. In certain embodiments, the EGF component may also include biologically active derivatives or fragments of EGF. Such biologically active derivatives or fragments are peptides with similar, but not identical, structure as the EGF from which they are derived or fragmented. Such biologically active derivatives and fragments have a similar function to the EGF from which they are derived or fragmented. The biological activity of such derivatives or fragments can be determined using conventional methods readily known by persons of ordinary skill in the art. For example, a derivative of EGF may be examined by determining whether the derivative is effective in increasing the moisture content of an epithelium of an eye.

The EGF is provided in an amount that does not substantially detrimentally affect the optical clarity and/or optical power of the contact lens while in use. The EGF may be included in the present contact lenses in any suitable amount effective to provide the desired result. Such amounts may be in a range of about 0.01% or about 5% or about 10% or about 15% to about 20% or about 30% or about 40% or about 50% or more of the hydrophilic polymeric material present in the contact lens.

The EGF component may be selectively provided on the posterior surface of the contact lens body. Or, the EGF component may be distributed substantially throughout the lens body, and in certain embodiments, may be provided on the anterior surface of the lens body.

The EGF component of the contact lens may be a liquid located on or in the lens body. For example, the EGF component may be a liquid, such as an aqueous fluid, that contains EGF and is suitable for storing a contact lens therein. The liquid preferably does not reduce the biological activity of the EGF, for example, by denaturing the EGF present therein. In certain embodiments, the liquid may be a saline solution, or a phosphate-buffered solution.

In some embodiments, the lens body comprises a polymeric material, and the EGF of the EGF component is provided on or in the lens body without being coupled to the polymeric material. For example, the EGF may be distributed substantially throughout the lens body and on the anterior and posterior surfaces thereof without being attached to the polymeric material This configuration may be obtained by placing a contact lens in a volume of liquid which contains EGF. Such a contact lens may be structured to be disposed of after a single use in an eye. In one embodiment, the lens is structured to be disposed of on a daily basis, such as a daily disposable contact lens.

In other embodiments, the EGF of the EGF component is immobilized by the polymeric material of the lens body. For example, the EGF may be physically immobilized by the polymeric material. The EGF component may be distributed substantially throughout the lens body, for example, within the lens body as well as on the anterior and/or posterior surfaces of the lens body. Or, the EGF component may be provided in a region located between the anterior surface and the posterior surface of the lens body. For example, the EGF component may be provided in depots, or as microparticles and/or nanoparticles, such as microspheres and/or nanospheres, located in the lens body.

In one embodiment, the lens body of the contact lens comprises a polymeric material, and the EGF of the EGF component is coupled to the polymeric material so that the EGF is released from the lens body for extended periods of time. The EGF may be released at a relatively constant rate while the contact lens is located on an eye. For example, the EGF may be released at a constant rate in which the amount of EGF constantly decreases from a time when the lens is placed on an eye to a time when the lens is removed from the eye. Or, the EGF may be released at a constant rate in which the amount of EGF released from the lens remains substantially the same while the lens is placed on an eye.

In other embodiments, the EGF may be released in at a non-constant rate. For example, a relatively larger amount of EGF may be released when the lens is placed on an eye, and a relatively smaller amount is released while the lens is located on the eye. Or, a relatively smaller amount of EGF may be released when the lens is placed on an eye, and periodic or random boluses of EGF may be released during the time in which the lens is placed on an eye.

The EGF may be coupled to the polymeric material so that the EGF is released for about seven days, either at a substantially constant rate or at a non-constant rate. This type of coupling may be most beneficial in contact lenses worn for a week. The EGF may also be coupled to the polymeric material so that the EGF is released for about thirty days. This type of coupling may be most beneficial in contact lenses worn for about a month.

In certain embodiments, the EGF is coupled to the polymeric material by a labile bond. The labile bond may be a covalent bond. The labile bond degrades over extended periods of time, for example by hydrolysis, thereby releasing the EGF from the lens body for extended periods of time. Typically, the bond will degrade from the surfaces of the lens body towards the interior of the lens body. For example, bonds between the EGF and the polymeric material located on the surface of the lens body will degrade before the bonds located in the interior of the lens body. The lenses that include an EGF component in which the EGF is coupled to the polymeric material of the lens body may be most beneficial as lenses that are structured to be worn for more than one day, such as for about one week or for about one month. Such lenses may also include a liquid or fluid that comprises EGF. The liquid or fluid may coat the lens body, and/or may be dispersed through the lens body. For example, the liquid or fluid may be applied to the contact lens when the lens is placed in a package system.

The EGF component includes an amount of EGF that is effective to promote a healthy epithelium on an eye. In certain embodiments, the amount of EGF is effective to maintain the moisture content of the epithelium, or to reduce drying of the epithelium. The amount of EGF may be effective to treat dry eye, or to reduce a risk of infection of the eye.

Some lenses in accordance with the present invention may be provided in a package system, which may be utilized for shipment and/or storage of the contact lens, including, for example, disposable packages. In accordance with the present invention, a package system comprises a contact lens, a liquid medium, and a container holding the contact lens and the liquid medium. The liquid medium comprises an amount of EGF that is effective to promote a healthy epithelium of an eye on which the lens is placed.

The contact lens of the package system may comprise a lens body formed from a polymeric material and an EGF coupled to the polymeric material. Such a lens may be structured to be disposed of after a week of use in an eye. The package system may also include a seal effective to seal the container. Such a seal may be effective in maintaining sterility of the contact lens located in the container.

The contact lens of the package system may also be structured to be disposed of after a single use in an eye. For example, the contact lens may be structured to be disposed of after a day of use in an eye.

The contact lens disclosed herein may be produced by a variety of methods. In one embodiment, a method of producing a contact lens comprises combining a polymeric material suitable for forming a contact lens with an amount of EGF effective to promote a healthy epithelium on the eye on which the lens is placed. The EGF may be blended with the polymeric material before the material is formed into a contact lens. Thus, the method may comprise a step of forming the combination of the polymeric material and the EGF into a contact lens. Alternatively, or in addition, the EGF may be combined with the polymeric material after the material is in the shape of a contact lens. For example, the EGF may be provided in a liquid medium in which the contact lens is placed, such as a liquid medium of the package system described herein. The method may also include a step of coupling the EGF to the polymeric material. The coupling step could be a part of the combining step, or a separate step performed after the combining step. The method may also include a step of placing the contact lens formed by the method set forth above into a container of a package. A step of sealing the package may also be desired.

In one embodiment, the EGF is included in the contact lenses during polymerization, for example, solution polymerization, to produce the hydrophilic polymeric material. The polymerizing step may be performed in a contact lens mold, for example, a conventional contact lens mold. The polymerizing step may take place in a manner substantially similar or analogous to the corresponding step in the conventional wet cast molding process for making hydrophilic contact lenses. The polymerization reaction conditions useful in the present methods are substantially the same as those used in conventional wet cast molding processes for producing hydrophilic contact lenses and, therefore, are not detailed herein. The resulting contact lens body preferably includes an interpenetrating network or a pseudo interpenetrating network of the hydrophilic polymeric material and the epithelial growth factor.

The contact lens disclosed herein may be used by placing the lens onto the epithelium of an eye so that the posterior surface of the lens body faces the anterior surface of the eye. The epithelium is typically substantially intact. However, the eye may be exhibiting one or more symptoms similar or identical to dry eye. Thus, the lens may be placed on a healthy or unhealthy eye. The EGF of the lens is released from the lens for a period of time, such as a day, a week, or a month. The EGF is effective to maintain or enhance the health of the epithelium.

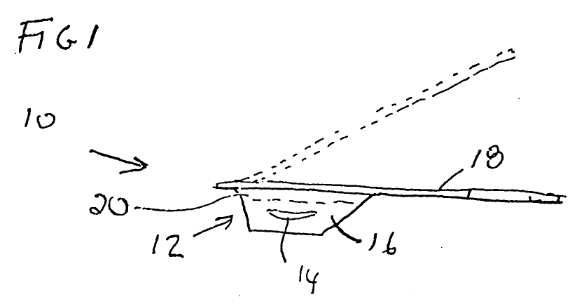

Referring now to FIG. 1, a package system in accordance with the present invention is shown at 10. Package system 10 includes a container 12, a contact lens 14, including a contact lens body including a hydrophilic polymeric material and an EGF component, a liquid medium 16, and a removable seal 18.

The container 12 and seal 18 are similar to the container and seal used in a conventional blister pack used with conventional hydrophilic contact lenses.

With the container 12 unsealed, the liquid medium 16 and the contact lens 14, directly from the contact lens mold, are placed therein. The seal 18 is placed over, and secured to the top of container 12, thereby sealing the compartment 20 containing the contact lens 14 in contact with the liquid medium 16.

The contact lens 14 can be used by opening seal 18 (as shown by the shadow lines in FIG. 1), removing lens 14 from compartment 20 and placing the lens into one's eye. The container 12, liquid medium 16 and seal 18 can then be properly disposed of.

All references, articles, publications and patents and patent applications cited herein are incorporated by reference in their entireties.

While this invention has been described with respect to various specific examples and embodiments, it is to be understood that the invention is not limited thereto and that it can be variously practiced within the scope of the following claims.

1. A contact lens comprising:
a contact lens body having an anterior surface, and a posterior surface structured to be placed on an epithelium of an eye; and
an epithelial growth factor component provided on or in the lens body, the epithelial growth factor component comprising an amount of an epithelial growth factor effective to promote a healthy epithelium of an eye on which the contact lens is placed.

2. The contact lens of claim 1, wherein the lens body comprises a hydrophilic polymeric material.

3. The contact lens of claim 2, wherein the hydrophilic polymeric material is obtained by polymerization of at least one hydrophilic monomeric component and at least one cross-linking monomeric component.

4. The contact lens of claim 3, wherein the hydrophilic monomeric component is selected from the group consisting of hydroxyalkyl acrylates, hydroxyalkyl methacrylates, N-vinyl pyrrolidone, acrylamides, vinyl alcohol, hydrophilic polyurethane precursors, glycerol acrylates, glycerol methacrylates, acrylates, methacrylates, substituted counterparts thereof and the like and mixtures thereof.

5. The contact lens of claim 1, wherein the lens body comprises a silicone hydrogel material.

6. The contact lens of claim 1, wherein the lens body comprises a polymeric material, and the epithelial growth factor is provided on or in the lens body without being coupled to the polymeric material.

7. The contact lens of claim 1, wherein the epithelial growth factor component is distributed substantially throughout the lens body.

8. The contact lens of claim 1, wherein the epithelial growth factor component is provided in a region located between the anterior surface and the posterior surface.

9. The contact lens of claim 1, wherein the lens body comprises a polymeric material, and the epithelial growth factor is coupled to the polymeric material so that the epithelial growth factor is released from the lens body for extended periods of time.

10. The contact lens of claim 9, wherein the epithelial growth factor is coupled to the polymeric material so that the epithelial growth factor is released for about seven days.

11. The contact lens of claim 9, wherein the epithelial growth factor is coupled to the polymeric material so that the epithelial growth factor is released for about thirty days.

12. The contact lens of claim 1, wherein the amount of epithelial growth factor is effective to treat dry eye.

13. The contact lens of claim 1, wherein the amount of epithelial growth factor is effective to reduce a risk of infection of the eye on which the lens body is placed.

14. A package system comprising:
a contact lens;
a liquid medium comprising an amount of epithelial growth factor effective to promote a healthy epithelium of an eye on which the contact lens is placed; and
a container holding the contact lens and the liquid medium.

15. The package system of claim 14 wherein the contact lens comprises a lens body formed from a polymeric material and an epithelial growth factor coupled to the polymeric material.

16. The package system of claim 15, wherein the contact lens is structured to be disposed of after a week of use in an eye.

17. The package system of claim 15, wherein the contact lens is structured to be disposed of after a day of use in an eye.

18. A method of producing a contact lens, the method comprising
combining a polymeric material suitable for forming a contact lens to be placed on an epithelium of an eye with an amount of epithelial growth factor effective to promote a healthy epithelium on the eye on which the contact lens is to be placed.

19. The method of claim 18, wherein the epithelial growth factor is blended with the polymeric material before the material is formed into a contact lens.

20. The method of claim 18, wherein the polymeric material is in the shape of a contact lens, and the epithelial growth factor is provided in a liquid in which the contact lens is placed.

21. The method of claim 18, wherein the combining step comprises coupling the epithelial growth factor to the polymeric material.
